(19) United States
(12) Patent Application Publication
(10) Pub. No.: US 2015/0236443 A1
(43) Pub. Date: Aug. 20, 2015

(54) MOUNTING APPARATUS AND MOUNTING ASSEMBLY FOR CONNECTOR

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHENG-MING YANG, Shenzhen (CN); YUAN LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/191,500

(22) Filed: Feb. 27, 2014

(30) Foreign Application Priority Data
Feb. 19, 2014 (CN) 2014100560605

(51) Int. Cl. H01R 13/60

(52) U.S. Cl. CPC H01R 13/60

(57) ABSTRACT

A mounting apparatus includes a receiving tray, a rotating member rotatably attached to the receiving tray, and a resisting member moveably attached to the rotating member. The receiving tray is used for receiving a connector and includes a side plate. The side plate includes a positioning portion. The rotating member includes a mounting means. The connector is sandwiched by the rotating member and the receiving tray. To engage the positioning portion with the mounting means, the rotating member is rotatable relative to the receiving tray. The resisting member is moveable relative to the rotating member and abuts the rotating member to prevent the positioning portion from disengaging from the mounting means. The disclosure further offers a mounting assembly.

### FIELD

The present disclosure relates to mounting apparatus and mounting assemblies, and particularly to a mounting apparatus and a mounting assembly for a connector.

### BACKGROUND

A connector is used to electronically connect a first object to a second object. Usually, a connector is received in a case to protect the connector from being damaged.

However, if the connector is secured to the case by screws, removing the screws is time-consuming and laborious.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus and a connector in accordance with an embodiment.

FIG. 2 is an assembled view of the mounting apparatus and the connector of FIG. 1, and a rotating member and a resisting member are located on an original state.

FIG. 3 is similar to FIG. 2, but the connector is slantingly located on a bottom plate of a receiving tray.

FIG. 4 is similar to FIG. 3, but the connector abuts the bottom plate.

FIG. 5 is similar to FIG. 2, but the rotating member abuts the connector.

FIG. 6 is similar to FIG. 5, but the resisting member abuts the rotating member.

FIG. 7 is a cross-sectional view of FIG. 6, taken along a line VII-VII.

FIG. 8 is a cross-sectional view of FIG. 6, taken along a line VIII-VIII.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

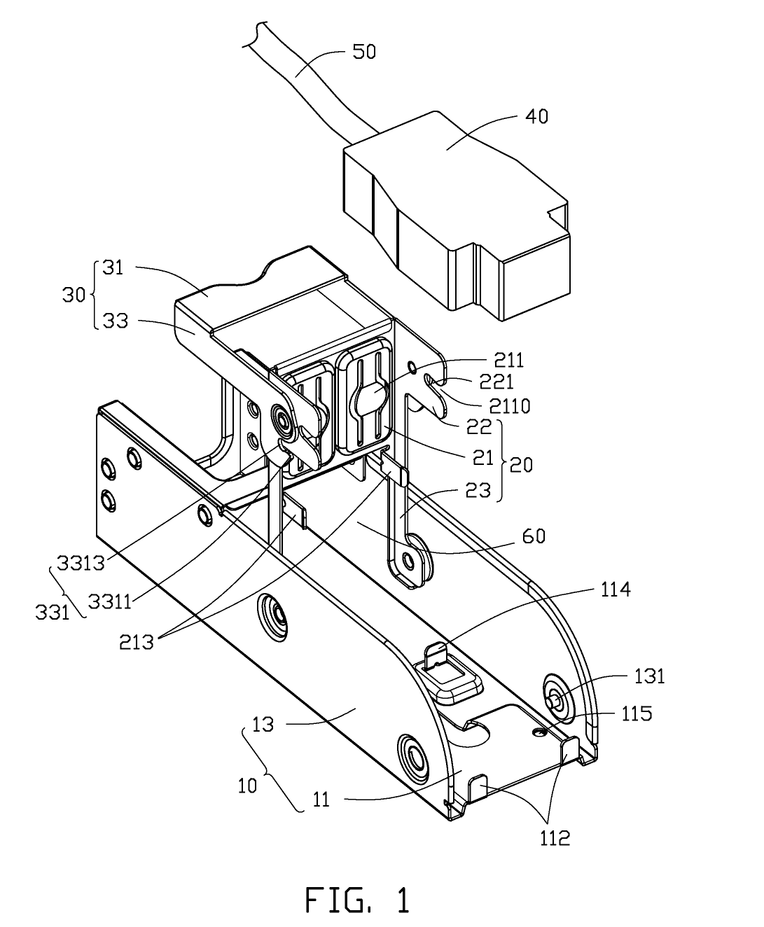

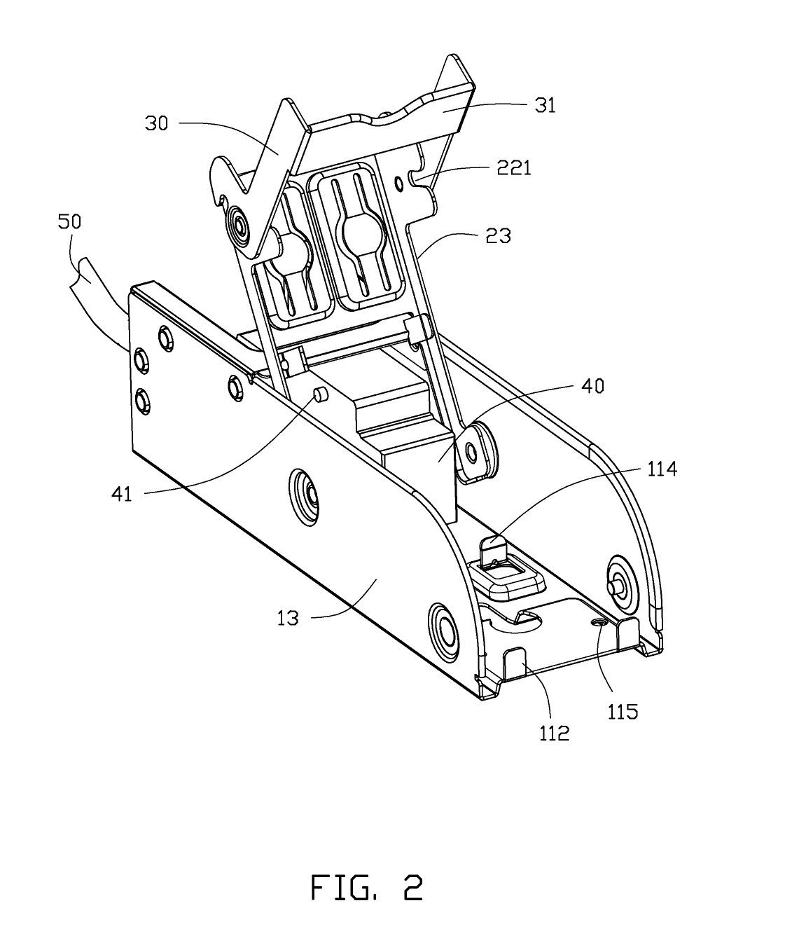

FIGS. 1-2 illustrate a mounting apparatus in accordance with an embodiment. The mounting apparatus comprises a receiving tray 10, a rotating member 20 rotatably attached to the receiving tray 10, and a resisting member 30 moveably attached to the rotating member 20. In one embodiment, the resisting member 30 is rotatably or slidably attached to the rotating member 20. The mounting apparatus is used to secure a connector 40 with a cable 50. Two securing posts 41 (see FIG. 2) are located on the connector 40.

The receiving tray 10 comprises a bottom plate 11 and two side plates 13 extending from opposite sides of the bottom plate 11. In one embodiment, each side plate 13 is substantially perpendicular to the bottom plate 11. Two first limiting pieces 112 and two second limiting pieces 114 (only one second limiting piece 114 is shown in FIG. 1) are located on the bottom plate 11. In one embodiment, the two first limiting pieces 112 extend perpendicularly from an edge of the bottom plate 11, and each second limiting piece 114 is substantially parallel to the first limiting piece 112. Two securing holes 115 (only one is shown) are located between the two first limiting pieces 112 and the second limiting pieces 114 and correspond to the two securing posts 41. A positioning portion 131 is located on each side plate 13. In one embodiment, the positioning portion 131 is a positioning post that is substantially perpendicular to the side plate 13.

The rotating member 20 comprises a pressing panel 21, two side panels 22 extending from opposite sides of the pressing panel 22, and two connecting arms 23. Two elastic pieces 211 are located on the pressing panel 21. Two retaining pieces 213 extend from the pressing panel 21. In one embodiment, each retaining piece 212 is substantially perpendicular to the pressing panel 21. The two retaining pieces 213 are used to abut opposite sides of the connector 40, to prevent the connector 40 from moving in a first direction that is substantially perpendicular to the side plate 13. A mounting means 221 is located on each side plate 22. In one embodiment, the mounting means 221 is a mounting slot, which comprises an entrance 2210. Each connecting arm 23 is connected to each side panel 22 and is rotatably attached to each side plate 13. The rotating member 20 is rotatable about a first axis that is substantially perpendicular to the side plate 13. A through hole 60 is located between the two connecting arms 23.

The resisting member 30 comprises a resisting panel 31 and two connecting panels 33. Each connecting panel 33 is rotatably attached to each side panel 22, so that the resisting member is rotatable about a second axis that is substantially parallel to the first axis. A blocking means 331 is located on each connecting panel 33. The blocking means 331 is used to engage with the positioning portion 131, to prevent the positioning portion 131 from disengaging from the mounting means 221. In one embodiment, the blocking means 331 is a blocking slot, which comprises a sliding slot 3311 and a blocking slot 3313 connected to the sliding slot 3311. The sliding slot 3311 and the blocking slot 3313 are substantially arcuate.

When the rotating member 20 and the resisting member 30 are in an original state (see FIG. 2), the rotating member 20 is located towards a first side (a back side) of the receiving tray 10, and an obtuse angel is defined between the rotating member 20 and the bottom plate 11. The resisting member 30 is facing towards a second side (a front side) of the receiving tray 10 opposite to the first side, and an acute angle is defined between a resisting panel 31 and the pressing panel 21. The connector 40 is located on the first side of the receiving tray 10 and extending through the through hole 60.

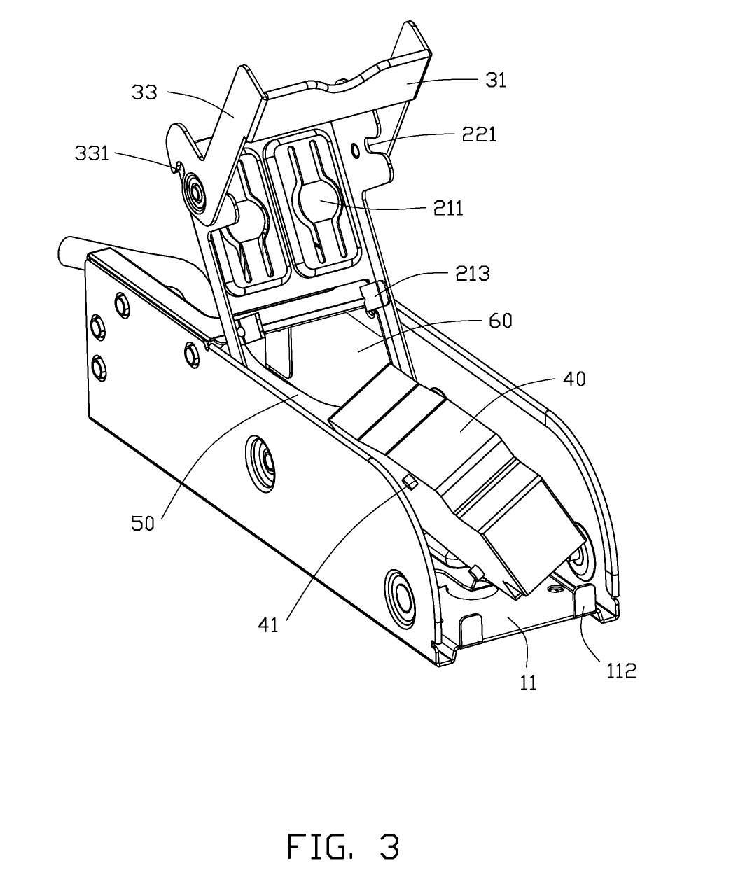

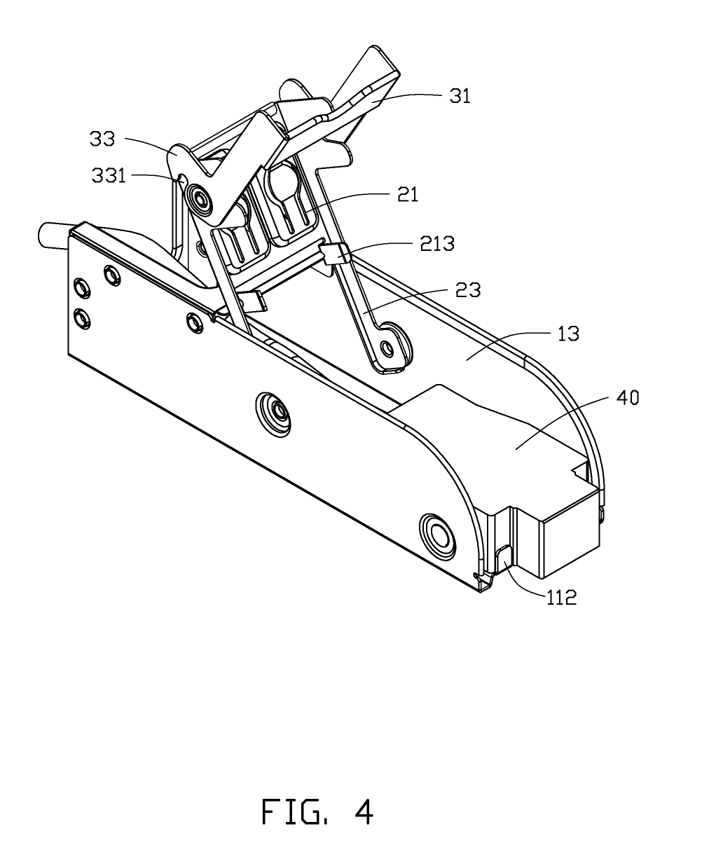

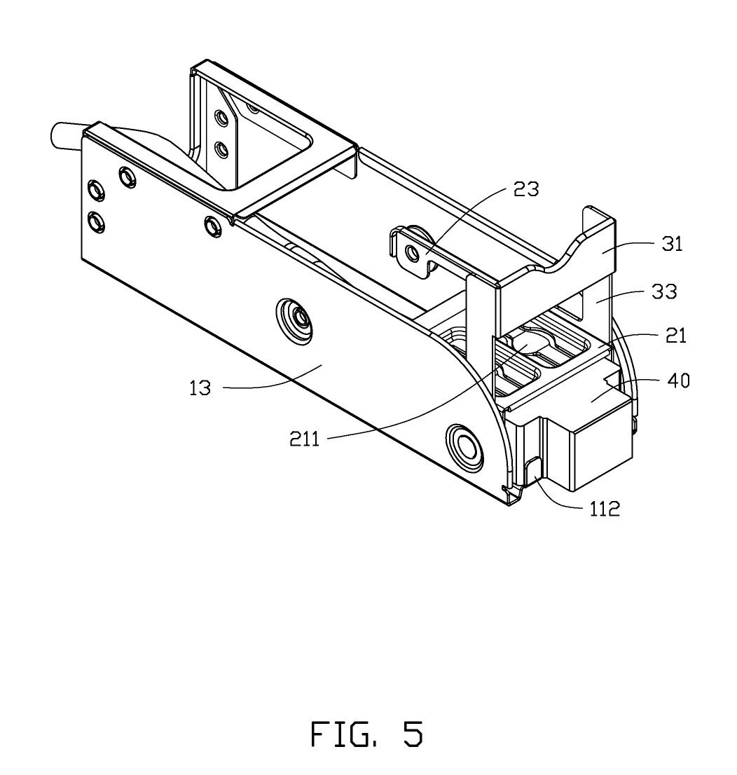

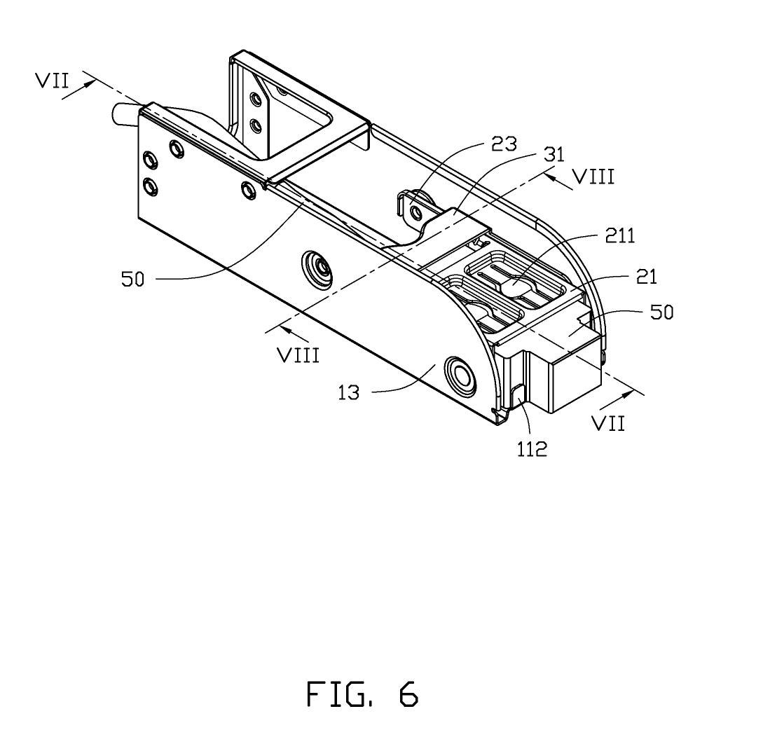

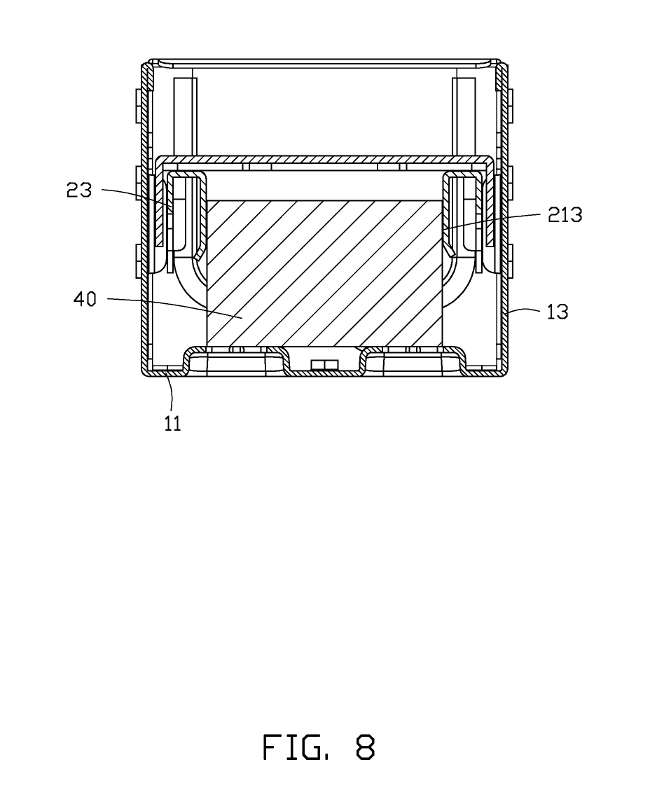

FIGS. 3-8 illustrate that in assembly of the mounting apparatus. When the connector 40 extends through the through hole 60, the connector 40 is rotated to be substantially parallel to the bottom plate 11 (see FIG. 3). When the connector 40 is located above the two first limiting pieces 112 and the second limiting pieces 114, the connector 40 is moved downward to the bottom plate 11 between the two first limiting pieces 112 and the second limiting pieces 114. The two first limiting pieces 112 and the second limiting pieces 114 together prevent the connector 40 from moving in a second direction that is substantially perpendicular to the first direction. The two securing posts 41 are engaged in the two securing holes 115 (see FIG. 4).

The rotating member 20 is rotated about the first axis in an anticlockwise direction towards the second side of the receiving tray 10, until the mounting means 221 is aligned with the positioning portion 131. To prevent the connector 40 from moving in a first direction (see FIG. 4), the rotating member 20 is further rotated, so that the positioning portion 131 is engaged in the mount 221. The pressing panel 21 abuts the connector 40, and the two retaining pieces 213 are resisted on opposite sides of the connector 40.

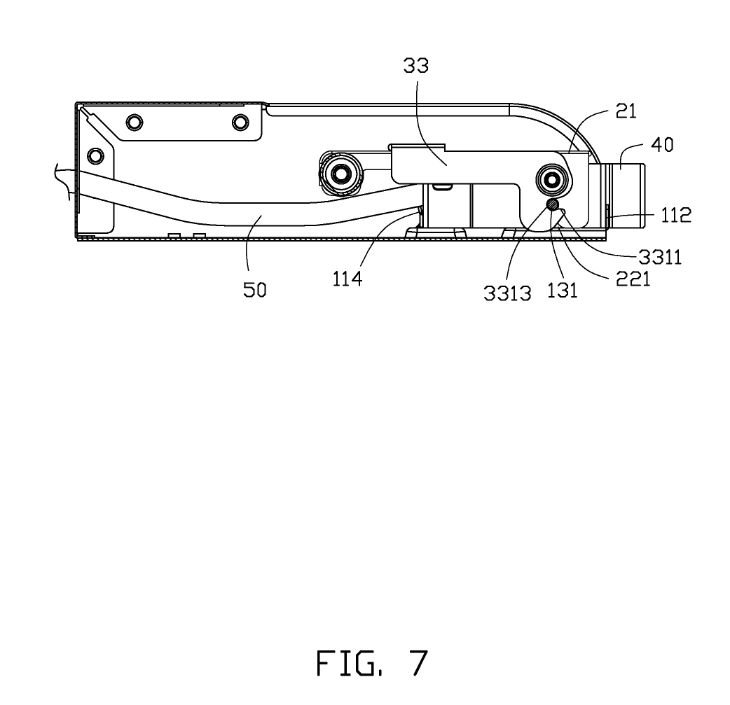

The resisting member 30 is rotated about the second axis in a clockwise direction toward the first side of the receiving tray 10, until the blocking slot 3311 is aligned with the positioning portion 131. The resisting member 30 is further rotated, and the positioning portion 131 can be slid through the sliding slot 3311 and positioned in the blocking slot 3313 (see FIG. 7). The resisting panel 31 is pressed on the pressing panel 21, and the positioning portion 131 is blocked by the blocking means 331 and cannot be disengaged from the mounting means 221.

In disassembly, the revisiting member 30 is rotated about the second axis in the anticlockwise direction and towards the second side of the receiving tray 10, to disengage the positioning portion 131 from the blocking means 331. Thus, the positioning portion 131 cannot be blocked by the blocking means 331. The rotating member 20 is rotated about the first axis in the clockwise direction, towards the second side of the receiving tray 10, and the positioning portion 131 disengages from the mounting means 221. When the rotating member 20 is located in the original state, the connector 40 is moved upward to disengage from the first limiting pieces 112 and the second limiting pieces 114. The securing posts 41 are removed from the securing holes 115. The connector 40 extends through the through hole 60 from the second side of the receiving tray 10 to the first side of the receiving tray 10. Thus, the connector 40 can be detached from the receiving tray 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a receiving tray configured for receiving a connector; the receiving tray comprising a side plate, and the side plate comprising a positioning portion;
a rotating member rotatably attached to the receiving tray; the rotating member comprising a mounting means; and
a resisting member moveably attached to the rotating member;
wherein the rotating member is rotatable relative to the receiving tray, to engage the positioning portion with the mounting means, the rotating member and the receiving tray together sandwiches the connector therebetween, and the resisting member is moveable relative to the rotating member to engage with the rotating member or the receiving tray, to prevent the positioning portion from disengaging from the mounting means.

2. The mounting apparatus of claim 1, wherein the resisting member is rotatable attached to the rotating member, the rotating member is rotatable in a first direction to abut the connector, and the resisting is rotatable in a second opposite direction to abut the rotating member.

3. The mounting apparatus of claim 2, wherein the rotating member is rotatable about a first axis relative to the receiving tray, and the resisting member is rotatable about a second axis that is substantially parallel to the first axis.

4. The mounting apparatus of claim 1, wherein the resisting member comprises a blocking means, and the blocking means abuts the positioning portion to prevent the positioning portion from disengaging from the mounting means.

5. The mounting apparatus of claim 4, wherein the blocking means comprises a sliding slot and a blocking slot connected to the sliding slot; and the sliding slot and the blocking slot are arcuate.

6. The mounting apparatus of claim 1, wherein the rotating member comprises a pressing panel, and an elastic piece is located on the pressing panel and configured to abut the connector.

7. The mounting apparatus of claim 6, wherein the rotating member further comprises two connecting arms connected to the pressing panel, the two connecting arms are rotatably attached to the receiving tray, and a through hole is defined between the two connecting arms and configured for the connector extending through.

8. The mounting apparatus of claim 7, wherein the rotating member further comprises at least two retaining pieces connected to the pressing panel, and the at least two retaining pieces are configured to abut the connector, to prevent the connector from moving in a first direction that is substantially perpendicular to the side plate.

9. The mounting apparatus of claim 8, wherein the receiving tray further comprises a bottom plate connected to the side plate, a first limiting piece and a second limiting piece are located on the bottom plate, and the first limiting piece and the second limiting piece are configured to abut the connector, to prevent the connector from moving in a second direction that is substantially perpendicular to the first direction.

10. The mounting apparatus of claim 9, wherein the bottom plate defines a securing hole, and the securing hole is configured to receive a securing post of the connector.

11. A mounting apparatus comprising:
a receiving tray configure for receiving a connector; the receiving tray comprising a side plate, and the side plate comprising a positioning portion;
a rotating member rotatably attached to the receiving tray; the rotating member comprising a mounting means; and
a resisting member moveably attached to the rotating member; the resisting member comprising a blocking means;
wherein the rotating member and the receiving tray together sandwiches the connector therebetween, the rotating member is rotatable relative to the receiving tray, to engage the positioning portion with the mounting means, and the resisting member is moveable relative to the rotating member to engage the blocking means with the mounting means, for preventing the positioning portion from disengaging from the mounting means.

12. The mounting apparatus of claim 11, wherein the resisting member is rotatable attached to the rotating member, the rotating member is rotatable in a first direction to abut the connector, and the resisting member is rotatable in a second opposite direction to abut the rotating member.

13. The mounting apparatus of claim 12, wherein the rotating member is rotatable about a first axis relative to the receiving tray, and the resisting member is rotatable about a second axis that is substantially parallel to the first axis relative to the rotating member.

14. The mounting apparatus of claim 11, wherein the blocking means is a slot and comprises a sliding slot and a blocking slot connected to the sliding slot; and the sliding slot and the blocking slot are arcuate.

15. The mounting apparatus of claim 11, wherein the rotating member comprises a pressing panel, and an elastic piece is located on the pressing panel and is configured to abut the connector.

16. The mounting apparatus of claim 15, wherein the rotating member further comprises two connecting arms connected to the pressing panel, the two connecting arms are rotatably attached to the receiving tray, and a through hole is defined between the two connecting arms and is configured for the connector extending through.

17. The mounting apparatus of claim 16, wherein the rotating member further comprises at least two retaining pieces connected to the pressing panel, and the at least two retaining pieces are configured to abut the connector, to prevent the connector from moving in a first direction that is substantially perpendicular to the side plate.

18. The mounting apparatus of claim 17, wherein the receiving tray further comprises a bottom plate connected to the side plate, a first limiting piece and a second limiting piece are located on the bottom plate, and the first limiting piece and the second limiting piece are configured to abut the connector, to prevent the connector from moving in a second direction that is substantially perpendicular to the first direction.

19. The mounting apparatus of claim 9, wherein the bottom plate defines a securing hole, and the securing hole is configured to receive a securing post of the connector.

20. A mounting assembly comprising:
a connector;
a receiving tray comprising a side plate, and the side plate comprising a positioning portion;
a rotating member rotatably attached to the receiving tray; the rotating member comprising a mounting means; and
a resisting member moveably attached to the rotating member;
wherein the connector is located between the rotating member and the receiving tray, the rotating member is rotatable relative to the receiving tray, to engage the positioning portion with the mounting means, and the resisting member is moveable relative to the rotating member and abuts the rotating member, to prevent the positioning portion from disengaging from the mounting means.
